(19) United States
(12) Patent Application Publication
(10) Pub. No.: US 2026/0282131 A1
(43) Pub. Date: Sep. 17, 2026

(54) TRAFFIC ROUTING OF USER EQUIPMENT BASED ON DUAL CONNECTIVITY CAPABILITY

(71) Applicant: T-Mobile USA, Inc., Bellevue, WA (US)

(72) Inventors: Timur Kochiev, Irvine, CA (US); Mochamad Mirza, Bothell, WA (US); Nishant Patel, Irvine, CA (US)

(21) Appl. No.: 19/076,668

(22) Filed: Mar. 11, 2025

(51) Int. Cl. H04W 76/15; H04W 28/02; H04W 40/02

(52) U.S. Cl. CPC H04W 76/15; H04W 28/0215; H04W 40/02

(57) ABSTRACT

The disclosed technology relates to methods and systems of routing user equipment (UE) traffic in a telecommunication network. Dual connectivity (DC) capability associated with multiple UEs is determined. The multiple UEs are divided into one or more traffic groups according to the DC capability. The one or more traffic groups are routed to corresponding master nodes of the telecommunication network for communication, thereby enabling the one or more traffic groups to establish DC with corresponding secondary nodes.

### BACKGROUND

Dual connectivity (DC) in telecommunication refers to a feature that allows a user equipment (UE) to simultaneously connect to two different base stations, commonly referred to as a master node (MN) and a secondary node (SN). The UE connects to the MN for primary connection and simultaneously establishes a secondary connection with the SN. DC is primarily used in telecommunication networks to enhance data throughput, improve coverage, and ensure a seamless user experience.

DC was first introduced in long-term evolution (LTE) to enable a UE to be connected to two LTE nodes. In 5G, DC was expanded such that a UE can be connected to both LTE and 5G nodes. Multiple types of DC exist, including: (1) Evolved-Universal Terrestrial Radio Access Network Dual Connectivity (EN-DC), wherein a UE is enabled to connect to both LTE and 5G nodes; and (2) New Radio Dual Connectivity (NR-DC), wherein a UE is enabled to connect to two 5G nodes.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3A illustrates DC layer management for different types of UEs within a telecommunication network.

FIG. 3B illustrates DC layer management for different types of UEs within a telecommunication network updated based on DC capabilities that can implement aspects of the present technology.

FIG. 4 is a flowchart representation of an example process of routing UE traffic in a telecommunication network in accordance with one or more embodiments of the present technology.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Continuous evolution of user equipment (UE) with dual connectivity (DC) capabilities is a significant aspect of the development of mobile technologies. The evolution of DC-capable UE is driven by the need to enhance network performance, improve user experience, and support increasing demand for high-speed, upgraded data services. DC was initially introduced in LTE-Advanced Pro (Release 13) to improve data rates and network efficiency by enabling UEs to connect to two LTE base stations simultaneously, allowing for carrier aggregation across different frequency bands.

With the introduction of 5G New Radio (NR) in Release 15, DC evolved to include connections between UEs and LTE base stations as well as 5G NR base stations. Subsequent releases continue to introduce additional and advanced features to DC, including combining multiple carriers from both LTE and 5G NR to achieve higher data rates, introducing Dynamic Spectrum Sharing (DSS) that enables LTE and 5G NR to share the same frequency dynamically to improve spectrum efficiency, and extending the concept of DC to include multiple connections, such as LTE, 5G NR, and Wi-Fi. Notably, Evolved-Universal Terrestrial Radio Access Network Dual Connectivity (EN-DC) enables a UE to connect to both LTE and 5G nodes—the LTE node serving as a master node and the 5G node serving as a secondary node. Additionally, New Radio Dual Connectivity (NR-DC) enables a UE to connect to two 5G nodes: a sub-6 gigahertz (GHz) range node, also known as frequency range 1 (FR1), serving as a master node, and a millimeter wave (mmWave) node, also known as frequency range 2 (FR2), serving as a secondary node. NR-DC UE is capable of operating entirely on a 5G stand-alone (SA) network, which is a network that operates independently of existing LTE infrastructure.

A 5G secondary node can be configured to support both EN-DC and NR-DC, with either the 4G node or the 5G node serving as the master node. However, practical implementation of the capability of a 5G secondary node can be constrained based on multiple factors. In practical deployment scenarios, UEs that are capable of EN-DC are often steered to FR1 SA networks, preventing the UEs from connecting to FR2 as a secondary node.

The technology disclosed herein addresses the challenges associated with deployment of UE with DC capabilities in a telecommunication network. The telecommunication network can determine and store DC capability associated with multiple UEs. The multiple UEs are divided into one or more traffic groups according to the DC capability. The one or more traffic groups can be routed to corresponding master nodes of the telecommunication network for communication, thereby enabling the one or more traffic groups to establish DC with corresponding secondary nodes.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

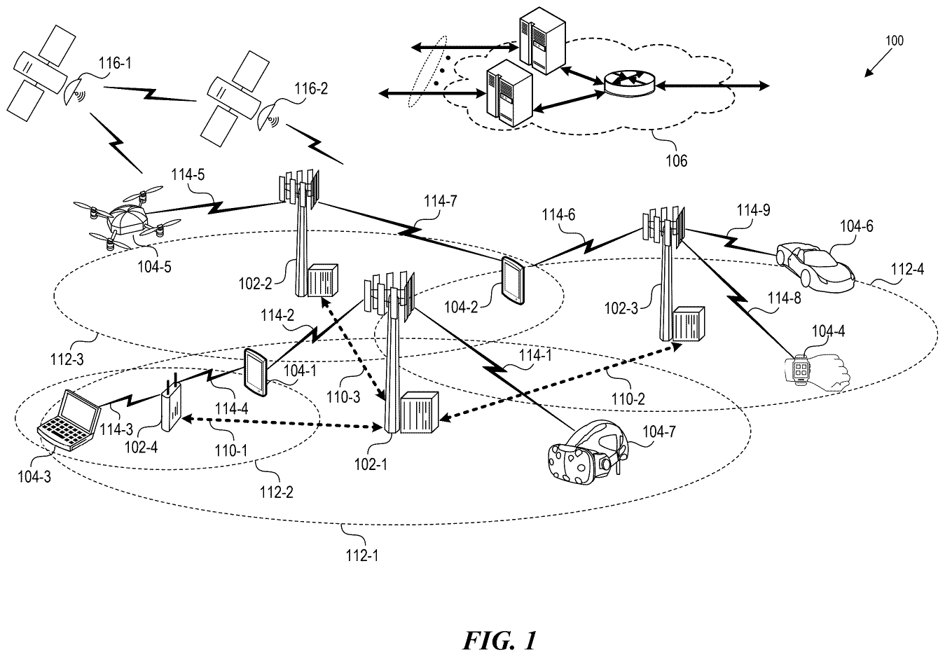

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmWave) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmWave communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) (e.g., using unpaired spectrum resources) operation. In some implementations, the communication links 114 include LTE and/or mmWave communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core Network Functions

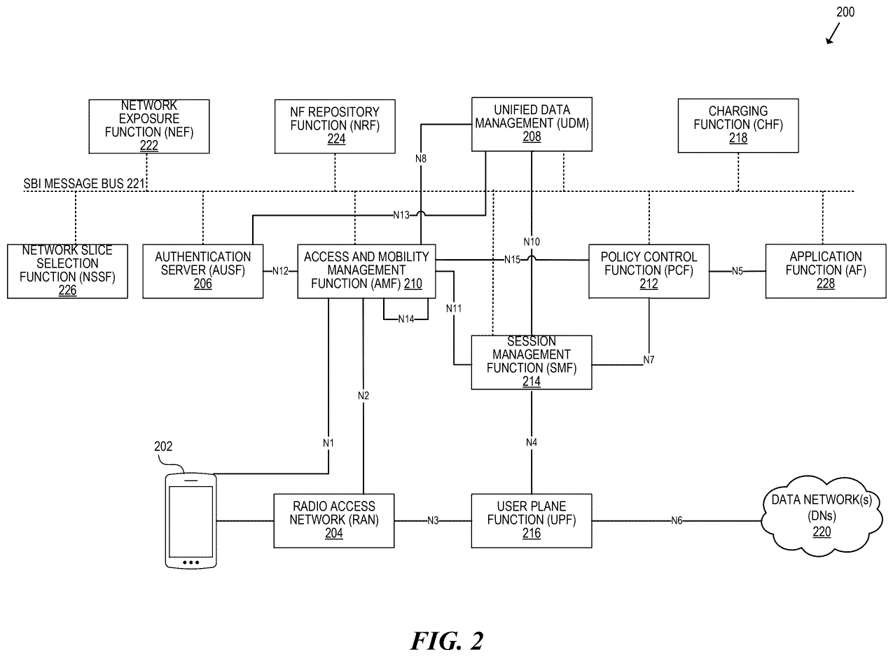

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

Telecommunication networks utilize a variety of frequency ranges to provide services to subscribers. LTE networks operate in a variety of frequency bands, primarily in the sub-3 GHz range but extending into higher frequency bands based on subscriber needs. Low-frequency bands (sub-1 GHz) are characterized by wide coverage and penetration capabilities. Mid-frequency bands (1 GHz to 3 GHz) are characterized by a balance between coverage and capacity, which are suitable for urban and suburban areas. High-frequency bands are utilized in some regions for LTE networks, though more commonly associated with 5G networks.

5G networks operate in a broader range of frequencies, including sub-6 GHz bands (FR1) and millimeter wave (mmWave) bands (FR2). FR1 broadly encompasses sub-6 GHz frequencies including bands typically used by LTE networks as well as new bands specifically allocated for 5G networks. FR2 ranges from 24.25 GHz to 71.0 GHz and is characterized by high data rates and limited coverage.

Telecommunication networks provide dual connectivity (DC) to UEs with such capabilities by enabling the UEs to maintain simultaneous connections to two different network nodes: a master node (MN) and a secondary node (SN). DC leverages the strengths of multiple network technologies and characteristics of the frequency bands to enhance data rates, coverage, and reliability. An MN is the primary node that handles main control plane functions and some user plane functions. An SN is a secondary node that provides additional user plane resources to enhance data throughput. Currently, many network operators assign UEs to frequency layers arbitrarily without considering DC capabilities associated with each UE. This can be problematic, especially when UEs that support EN-DC are routed to FR1 SA network nodes, preventing the UEs from utilizing FR2. As such, a more dynamic approach to UE assignment is crucial in order to ensure that UEs with specific DC capabilities fully benefit from the advantages associated with having a secondary connection to FR2.

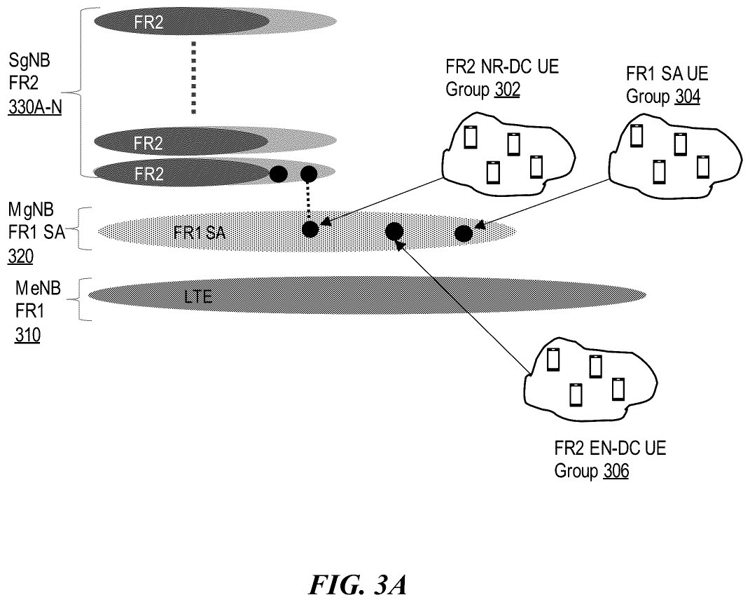

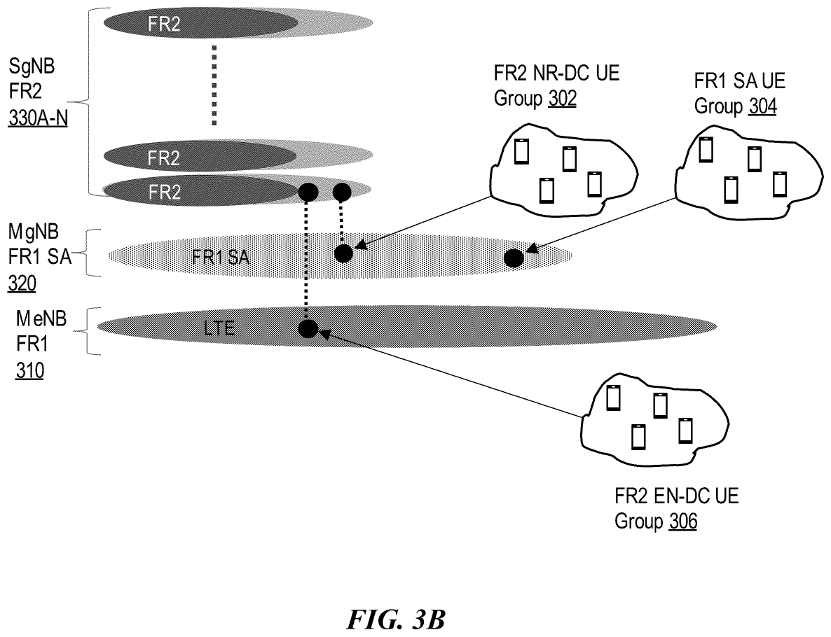

FIG. 3A illustrates DC layer management for different types of UEs within a telecommunication network. As illustrated, the telecommunication network is configured to provide connectivity to UEs via multiple stations, including master eNB (MeNB) FR1 310, stand-alone master gNB (MgNB) FR1 SA 320, and secondary gNBs (SgNB) FR2 330A-N. MeNB FR1 310 is an LTE node operating in FR1 that can function as an MN in an EN-DC configuration. MgNB FR1 SA 320 is a 5G node operating in FR1 that can function as an MN in an NR-DC configuration.

As illustrated in FIG. 3A, UEs that connect to the telecommunication network can be grouped based on connectivity capabilities. FR2 NR-DC UE group 302 represents a group of UEs that are capable of connecting simultaneously to two 5G nodes. FR1 SA UE group 304 represents a group of UEs that are capable of connecting to a stand-alone network. A non-stand-alone (NSA) in 5G refers to a 5G network that operates in conjunction with an existing LTE network. FR2 EN-DC UE group 306 represents a group of UEs that are capable of connecting simultaneously to one 5G node and one LTE node.

When UEs in the FR2 NR-DC UE group 302 are assigned to MgNB FR1 SA 320, the UEs can connect simultaneously to SgNBs FR2 330A-N, represented by dotted lines in FIG. 3A. This is because the NR-DC UEs are capable of connecting to both the MgNB and the SgNBs. In contrast, when UEs in the FR2 EN-DC UE group 306 are assigned to MgNB FR1 SA 320, the UEs are unable to connect simultaneously to the SgNBs FR2 330A-N. This is because the UEs in the FR2 EN-DC UE group 306 are incapable of connecting to both the MgNB and the SgNBs. Even though the UEs are capable of utilizing high-frequency mmWave bands by operating in the FR2 spectrum, the UEs are unable to connect to the SgNBs because of the existing connection to the MgNB.

FIG. 3B illustrates DC layer management for different types of UEs within a telecommunication network updated based on DC capabilities that can implement aspects of the present technology. In order to ensure that UEs with DC capabilities take full advantage of simultaneous connections to multiple nodes, the telecommunication network can implement traffic steering based on DC capabilities of each UE.

The telecommunication network in FIG. 3B detects and records DC capabilities of each UE. This can be achieved through the initial registration process or through capability exchange procedures during which the UEs communicate supported features to the telecommunication network. The telecommunication network can maintain a database of UE capabilities to facilitate efficient resource allocation and network planning. As illustrated in FIG. 3B, the telecommunication network can group the UEs into different groups based on the capabilities of the UEs.

The telecommunication network, upon determining that a UE is a part of the FR2 NR-DC UE group 302, can assign the UE to MgNB FR1 SA 320. The UE can connect simultaneously to SgNBs FR2 330A-N based on the NR-DC capability. Similarly, the telecommunication network, upon determining that a UE is part of the FR2 EN-DC UE group 306, can assign the UE to MeNB FR1 310. Such traffic steering enables the UE to connect simultaneously to SgNBs FR2 330A-N based on the EN-DC capability. Traffic steering of the UE based on UE capabilities enables the UE to utilize mmWave bands of SgNBs FR2330A-N.

In some implementations, the telecommunication network can assign UEs that are incapable of NR-DC or EN-DC to FR1 SA UE group 304. The default node assigned to the group can be MgNB FR1 SA 320, which handles both control plane and user plane functions for the UEs in the FR1 SA UE group 304. In other implementations, UEs that are incapable of NR-DC or EN-DC may be assigned to a FR1 NSA UE group, which is omitted in FIG. 3B. The default node assigned to the FR1 NSA UE group can be MeNB FR1, which handles primary control plane functions and provides LTE connectivity to the UEs in the FR1 NSA UE group, while a 5G gNB provides additional user plane resources. The default node assignment can depend on multiple factors, including network configuration and UE capabilities.

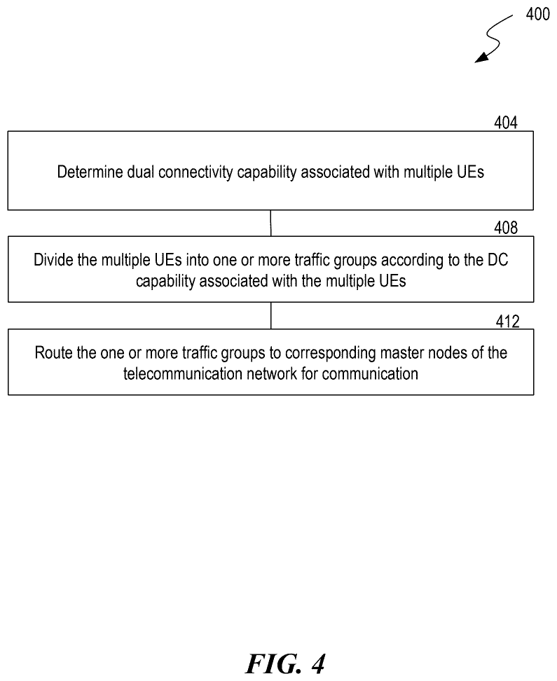

FIG. 4 is a flowchart representation of an example process 400 of routing UE traffic in a telecommunication network in accordance with one or more embodiments of the present technology. Other implementations of the process 400 include additional, fewer, or different network components and/or additional, fewer, or different steps or involve performing the steps in different orders.

At Operation 404, a telecommunication network determines DC capability associated with multiple UEs. The DC capability identifies whether a UE of the multiple UEs supports different types of DC, such as E-UTRA Network Dual Connectivity (EN-DC) or New Radio Dual Connectivity (NR-DC). In some implementations, the determining of the DC capability starts with receiving, from a UE of the multiple UEs, an initiation to register with the telecommunication network. The initiation can be an attach request or a registration request to the telecommunication network.

Upon receiving the initiation, the telecommunication network can accept the initiation and respond with a message, such as Attach Accept or Registration Accept. The response message by the telecommunication network can include a request for UE capabilities to the UE. In response to receiving the message, the UE can send a capability information response to the telecommunication network. The capability information response can include a comprehensive list of the UE's capabilities, including supported Radio Access Technologies (RATs), supported frequency bands, types of dual connectivity supported (e.g., EN-DC or NR-DC), supported carrier aggregation configurations, supported multi-input, multi-output (MIMO) configurations, and other supported features (voice-over LTE, voice-over NR, etc.). In some implementations, the telecommunication network stores the DC capability associated with the multiple UEs in a database of the telecommunication network.

At Operation 408, the telecommunication network can divide the multiple UEs into one or more traffic groups according to the DC capability associated with the multiple UEs. The one or more traffic groups can include a traffic group of UEs supporting NR-DC and another traffic group of UEs supporting EN-DC. The one or more traffic groups can also include a traffic group of UEs that do not support NR-DC and EN-DC. The UEs are grouped based on DC capability in order to ensure that UEs that support DC are assigned to appropriate master nodes and secondary nodes.

At Operation 412, the telecommunication network can route the one or more traffic groups to corresponding master nodes of the telecommunication network. The traffic group of UEs supporting NR-DC is routed to a 5G master node, and the traffic group of UEs supporting EN-DC is routed to an LTE master node. Consequently, the telecommunication network enables the traffic group of UEs supporting either NR-DC or NR-DC to establish DC with a 5G secondary node. The routing of the traffic groups ensures that UEs with DC capability utilize both the master nodes and the secondary nodes.

In some implementations, the one or more traffic groups can include a traffic group of UEs incapable of supporting DC. The traffic group of UEs incapable of supporting DC can be routed to a default master node. If the telecommunication network is a 5G network, the default master node can be a 5G stand-alone node that works independently of LTE. In other implementations, the default master node can be an LTE node serving as an anchor for control plane functions, while a separate 5G node provides additional user plane resources.

In other implementations, the telecommunication network can be further configured to periodically monitor connections between the traffic groups and the master nodes of the telecommunication network. Upon identifying a traffic group routed to a master node other than the corresponding master node to which the telecommunication network initially routed the traffic group, the telecommunication network can reroute the identified traffic group to the corresponding master node.

### Computer System

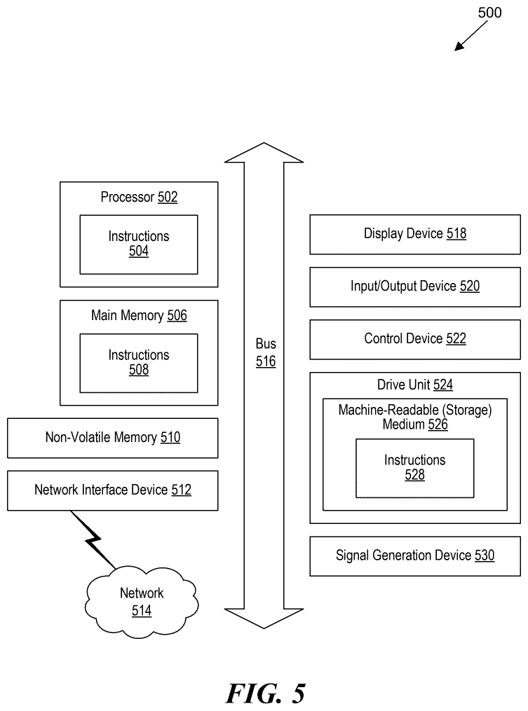

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer (SBC) system, or a distributed system such as a mesh of computer systems, or it can include one or more cloud components in one or more networks. Where appropriate, one or more computer systems 500 can perform operations in real time, in near real time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable (storage) medium 526) can be local, remote, or distributed. Although shown as a single medium, the machine-readable (storage) medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computer system 500. The machine-readable (storage) medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for routing of user equipment (UE) traffic in a telecommunication network, comprising:
determining dual connectivity (DC) capability associated with multiple UEs,
wherein the DC capability identifies whether a UE of the multiple UEs supports Evolved-Universal Terrestrial Radio Access Network Dual Connectivity (EN-DC) or New Radio Dual Connectivity (NR-DC);
dividing the multiple UEs into one or more traffic groups according to the DC capability associated with the multiple UEs,
wherein the one or more traffic groups include a first traffic group of UEs supporting NR-DC and a second traffic group of UEs supporting EN-DC; and
routing the one or more traffic groups to corresponding master nodes of the telecommunication network for communication, thereby enabling the one or more traffic groups to establish DC with corresponding secondary nodes, wherein the first traffic group of UEs is routed to a 5G master node, and wherein the second traffic group of UEs is routed to an LTE master node.

2. The method of claim 1, wherein the dual connectivity (DC) capability associated with the multiple UEs is stored in a database of the telecommunication network.

3. The method of claim 1, wherein the determining of the DC capability associated with the multiple UEs further comprises:
receiving, from a UE of the multiple UEs, an initiation to register with the telecommunication network;
accepting the initiation to register with the telecommunication network;
transmitting a request for UE capabilities to the UE; and
receiving, from the UE of the multiple UEs, a response to the request,
wherein the response comprises DC capability associated with the UE.

4. The method of claim 1, further comprising:
periodically monitoring connections between the one or more traffic groups and the master nodes of the telecommunication network; and
upon identifying a traffic group routed to a master node other than the corresponding master node, rerouting the traffic group to the corresponding master node.

5. The method of claim 1, further comprising:
enabling the first traffic group of UEs to establish DC with a 5G secondary node.

6. The method of claim 1, further comprising:
enabling the second traffic group of UEs to establish DC with a 5G secondary node.

7. The method of claim 1, wherein the one or more traffic groups include a third traffic group of UEs incapable of supporting EN-DC and NR-DC, the method further comprising:
routing the third traffic group of UEs to a default master node.

8. A non-transitory, computer-readable storage medium comprising instructions recorded thereon, wherein the instructions, when executed by at least one data processor of a system, cause the system to:
determine dual connectivity (DC) capability associated with multiple user equipments (UEs) of a telecommunication network,
wherein the DC capability identifies whether a UE of the multiple UEs supports Evolved-Universal Terrestrial Radio Access Network Dual Connectivity (EN-DC) or New Radio Dual Connectivity (NR-DC);
divide the multiple UEs into one or more traffic groups according to the DC capability associated with the multiple UEs,
wherein the one or more traffic groups include a first traffic group of UEs supporting NR-DC and a second traffic group of UEs supporting EN-DC; and
route the one or more traffic groups to corresponding master nodes of the telecommunication network for communication, thereby enabling the one or more traffic groups to establish DC with corresponding secondary nodes, wherein the first traffic group of UEs is routed to a 5G master node, and wherein the second traffic group of UEs is routed to an LTE master node.

9. The non-transitory, computer-readable storage medium of claim 8, wherein the dual connectivity (DC) capability associated with the multiple UEs is stored in a database of the telecommunication network.

10. The non-transitory, computer-readable storage medium of claim 8, wherein the instructions further cause the system to:
receive, from a UE of the multiple UEs, an initiation to register with the telecommunication network;
accept the initiation to register with the telecommunication network;
transmit a request for UE capabilities to the UE; and
receive, from the UE of the multiple UEs, a response to the request,
wherein the response comprises DC capability associated with the UE.

11. The non-transitory, computer-readable storage medium of claim 8, wherein the instructions further cause the system to:
periodically monitor connections between the one or more traffic groups and the master nodes of the telecommunication network; and
upon identifying a traffic group routed to a master node other than the corresponding master node, reroute the traffic group to the corresponding master node.

12. The non-transitory, computer-readable storage medium of claim 8, wherein the instructions further cause the system to:
enable the first traffic group of UEs to establish DC with a 5G secondary node.

13. The non-transitory, computer-readable storage medium of claim 8, wherein the instructions further cause the system to:
enable the second traffic group of UEs to establish DC with a 5G secondary node.

14. The non-transitory, computer-readable storage medium of claim 8, wherein the one or more traffic groups include a third traffic group of UEs incapable of supporting EN-DC and NR-DC, wherein the instructions further cause the system to:
route the third traffic group of UEs to a default master node.

15. A system comprising:
at least one hardware processor; and
at least one non-transitory memory storing instructions, which, when executed by the at least one hardware processor, cause the system to:
determine dual connectivity (DC) capability associated with multiple user equipments (UEs) of a telecommunication network,
wherein the DC capability identifies whether a UE of the multiple UEs supports Evolved-Universal Terrestrial Radio Access Network Dual Connectivity (EN-DC) or New Radio Dual Connectivity (NR-DC);
divide the multiple UEs into one or more traffic groups according to the DC capability associated with the multiple UEs,
wherein the one or more traffic groups include a first traffic group of UEs supporting NR-DC and a second traffic group of UEs supporting EN-DC; and
route the one or more traffic groups to corresponding master nodes of the telecommunication network for communication, thereby enabling the one or more traffic groups to establish DC with corresponding secondary nodes.

16. The system of claim 15, wherein the dual connectivity (DC) capability associated with the multiple UEs is stored in a database of the telecommunication network.

17. The system of claim 15, wherein the instructions further cause the system to:
receive, from a UE of the multiple UEs, an initiation to register with the telecommunication network;
accept the initiation to register with the telecommunication network;
transmit a request for UE capabilities to the UE; and
receive, from the UE of the multiple UEs, a response to the request,
wherein the response comprises DC capability associated with the UE.

18. The system of claim 15, wherein the instructions further cause the system to:
periodically monitor connections between the one or more traffic groups and the master nodes of the telecommunication network; and
upon identifying a traffic group routed to a master node other than the corresponding master node, reroute the traffic group to the corresponding master node.

19. The system of claim 15, wherein the instructions further cause the system to:
enable the first and second traffic groups of UEs to establish DC with a 5G secondary node.

20. The system of claim 15, wherein the one or more traffic groups include a third traffic group of UEs incapable of supporting EN-DC and NR-DC, wherein the instructions further cause the system to:
route the third traffic group of UEs to a default master node.
